(19) United States
(12) Patent Application Publication
(10) Pub. No.: US 2004/0207330 A1
(43) Pub. Date: Oct. 21, 2004

(54) Electroluminescent device

(76) Inventors: Gary Charles Ruffell, Camberley (GB); Richard Thomas Stiggants, Frimley (GB); Tony Fisk, Camberley (GB)

Correspondence Address: Ira S Dorman, Suite 200, 330 Roberts Street, East Hartford, CT, 06108, US

(21) Appl. No.: 10/480,703

(22) PCT Filed: Jun. 13, 2002
(86) PCT No.: PCT/GB02/02611

(30) Foreign Application Priority Data
Jun. 13, 2001 (GB) 0114413.8

(51) Int. Cl. H01J 1/62

(52) U.S. Cl. 315/169.3; 313/510

(57) ABSTRACT

An electroluminescent device has components comprising an electroluminescent panel (6), a DC power source (20), for example in the form of a rechargeable battery, and an inverter (22) connected to the DC power source to power the electroluminescent panel. The components are sealed together. Where the DC power source is rechargeable, the power source may include charging means (30), which charging means may be adapted to be coupled to an external power supply by means of electrical induction.

The present invention relates to electroluminescent devices and, more particularly but not exclusively, to such devices that can be affixed to clothing or other articles where high visibility is required, for example for safety purposes.

Electroluminescent displays which are formed as flexible and laminar panels or wires are commercially available. These displays require an AC power source. The colour of the light emitted by such electroluminescent displays can be controlled in a known manner by the use of different phosphorescent substances or the frequency of the activating power supply. Such displays are widely used to provide flat panel displays in portable computers. However, they may also be arranged to provide simple illuminated panels and it is the use of electroluminescent panels in this mode which is relevant to the present invention.

U.S. Pat. No. 4,999,936 (Calamia) describes one example of the use of an electroluminescent panel of this nature for the purposes of providing an illuminated sign for use on clothing. Calamia teaches the use of a separate pocket to house the various components of the power supply. This pocket is then connected to the electroluminescent panel by wires. A manually operated switch is provided to turn the panel on and off.

The presence of wires running through or over items of clothing presents a safety risk.

Lights are often used as safety devices to draw attention to the location of an individual or an obstacle such as a step. However, a light that is always on is a waste of energy.

It is therefore an object of the present invention to overcome or at least ameliorate the above disadvantages.

According to the present invention there is provided an electroluminescent device having components comprising an electroluminescent panel, a DC power source, and an inverter connected to the DC power source to power the electroluminescent panel, wherein the components are sealed together.

The components may be permanently sealed together.

The components may be sealed together by means of a polymer matrix or inside an envelope.

The inverter may be of the charge pump type.

Light sensitive means may be provided for controlling the power to the panel in response to ambient light levels. Such a device can be used to illuminate the panel only when needed. For example, the panel may switch on automatically as a warning light, for example at the leading edge of a step, in low ambient light levels.

Alternatively, or additionally, smoke sensitive means may be provided for controlling power to the panel in response to the presence of smoke. Light from the electroluminescent panel penetrates light smoke easily and the device can therefore be used on safety wear or other equipment such as fire exit signs, extinguishers and blankets that do not otherwise need to be illuminated all the time.

Alternatively, or additionally, gas sensitive means may be provided for controlling power to the panel in response to the presence of gas.

Alternatively, or additionally, water sensitive means may be provided for controlling power to the panel in response to the presence of water.

Alternatively, or additionally, electrocardiogram means may be provided for controlling power to the panel in response to the presence of a heart beat.

An opaque stencil may be superimposed in front of the electroluminescent panel. The stencil may contain a reflective material and/or a passive luminous material.

The electroluminescent panel may be shaped to define a desired symbol. Alternatively, or additionally, phosphorescent material in the electroluminescent panel may be shaped to define a desired symbol.

The DC power source may be rechargeable and may, for example, comprise a battery such as at least one lithium polymer cell. The DC power source may include charging means for recharging the power source. The charging means may be adapted to be coupled to an external power supply by means of electrical induction.

Alternatively, or additionally, the DC power source may comprise a kinetic energy supply. Alternatively, or additionally, the DC power source may comprise a water-activated cell. Alternatively, or additionally, the DC power source may comprise at least one solar cell.

Thus the present invention provides an electroluminescent device which in certain embodiments eliminates the need for external wiring. The DC power source, such as a battery, may be connected to a charger by induction. This eliminates the need for any external connections and provides for a completely sealed device.

For a better understanding of the present invention and to show more clearly how it may be carried into effect reference will now be made, by way of example, to the accompanying drawings in which:

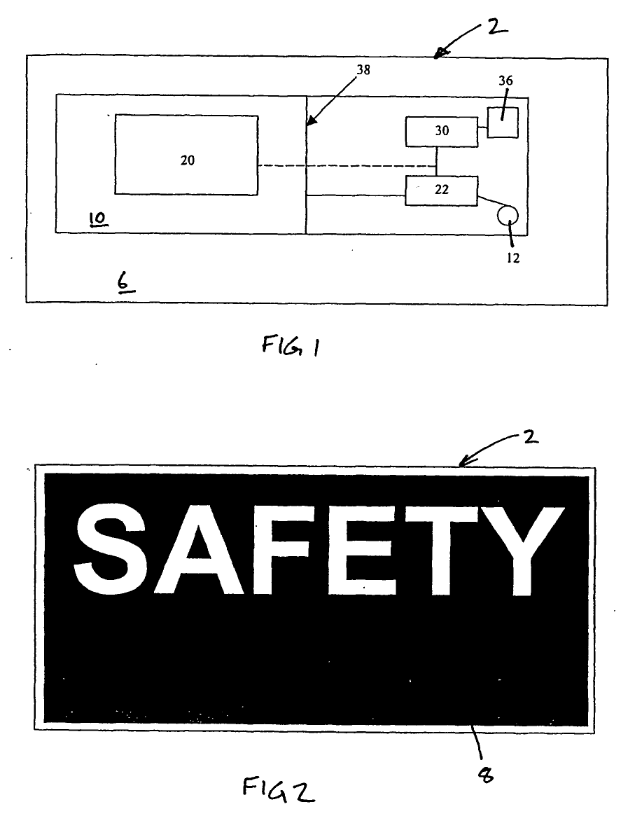

FIG. 1 shows a diagram of an embodiment of an electroluminescent device according to the present invention and showing the component layout from the rear of a panel;

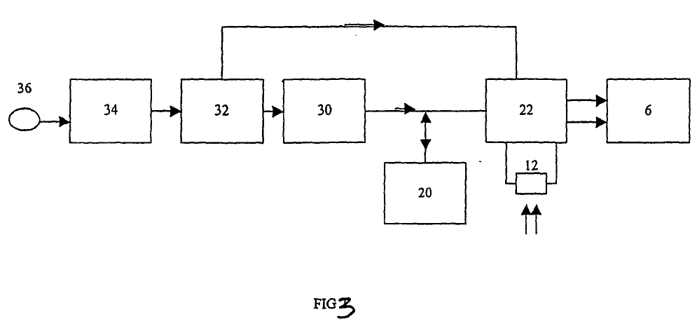

FIG. 2 shows a front view of the device of FIG. 1; and

FIG. 3 shows a block diagram of the electronic components of the device.

The drawings show an electroluminescent device 2 in the form of a sealed unit. The components of the device are an electroluminescent panel 6, which is partially covered by a stencil 8, and a power supply 10, together with supporting electronics for driving the panel 6 and charging the power supply 10 as well as control means 12 which can turn the panel on and off in response to ambient light levels.

The electroluminescent panel 6 is shown in this embodiment as a rectangular panel partially covered by the stencil 8. The opaque stencil 8 may be provided with a high reflective and/or passive luminous surface so that the marking is visible in high ambient light level conditions when the electroluminescent panel is turned off by the control means 12. The opaque stencil 8 may be created by silk screen printing an opaque print onto the surface of the electroluminescent panel 6 and then applying varnish. Alternatively or additionally, the panel 6 itself may be shaped to define a desired word or symbol or the panel can be manufactured with phosphor only in the area of the characters on the panel. Suitable electroluminescent panels 6 are manufactured by Elumion in Caerphilly, South Wales, Pacel Electronics Ltd., of Poole, Dorset and Elumin8 (RTM) of Ferndown, Dorset. Flexible electroluminescent panels can alternatively be used.

The power supply 10 incorporates a DC power source 20 connected to an AC inverter 22 in order to provide a signal at the required frequency to the panel 6. The DC power supply may be one of several types of small or laminar power sources. For example, a (rechargeable) battery such as a nickel metal hydride flat flexi-cell could be used. Solar cells, water-activated cells or a kinetic supply are also suitable, either alone or in combination with a (rechargeable) battery. Flexible power sources such a lithium polymer cells are particularly suitable and these can be obtained from Valence Technology in Newtown Abbey, County Antrim, or Ultralife (RTM) Batteries Ltd., in Abingdon, Oxfordshire. The output of the DC power source 20 is fed to the inverter 22, which converts the primary DC supply to a variable frequency high voltage supply, which in turn is fed to the electroluminescent panel 6 via a bus bar 38. The inverter 22 can have a permanent output resulting in a fixed luminosity of the panel 6, or a light-dependent output which alters the light output from the electroluminescent panel according to ambient light levels. The provides the control means 12.

The inverter 22 comprises a Supertex HV830, available from Supertex Inc., of Sunnyvale, Calif. The inverter 22 converts the DC low voltage supply to a high voltage, typically +/−100 volts, AC supply. Another suitable inverter can be obtained from IMP Inc., of San Jose, Calif.

The inverter 22 is ideally of the charge pump type in which a DC power source powers an oscillator which, during a positive cycle, builds up an electrical potential in an inductor. On a negative cycle of the oscillator, current from the inductor is passed to a storage capacitor, charging it to a high voltage, in order to provide the power required by the electroluminescent panel 6.

In a preferred embodiment, the control means 12 is a light dependent resistor so that the AC voltage is supplied to the electroluminescent panel 6 only when ambient light levels fall below a predetermined level. The light dependent resistor can be obtained from EG & G Vatec, of St Louis, Mo. In alternative or additional embodiments, other control means can be used such as smoke, gas, water or electrocardiogram detecting switches so that the electroluminescent panel 6 activates when in the presence of smoke, gas, water and/or where the heart rate of an individual increases beyond a certain level.

In embodiments in which the power source 20 is rechargeable, charging means 30 is provided. This would normally require an external electrical contact to provide for connection to an external power supply. However, in the embodiment shown, the charging means 30 is coupled to an external power source using induction charging via an induction loop 36 connected to an AC/DC converter 34. This avoids the need for an external electrical contact to connect a battery charger and results in a completely and permanently sealed device. The charging means 30 is controlled by a charge control logic device 32. The charge control logic device 32 switches off the electricity supply to the inverter 22 when the charging means is charging the power supply 20. A suitable charging means 30 for lithium polymer batteries may be selected from the Benchmarq range of chargers from Texas Instruments (RTM).

Using a charging means 30 that is coupled by electrical induction provides that the electroluminescent device 2 is intrinsically safe and meets the strict requirements for use of electrical devices at petrol stations, oil refineries and on board aircraft.

In addition, the control electronics may include a microprocessor such as a PIC device which can be obtained from Arizona Microchip, Arizona. Such a microprocessor can be used to control hue and luminance of the electroluminescent panel 6.

The control electronics may also include a circuit for strobing the power supply to the electroluminescent panel 6.

In order to seal the components of the device together, the electronics are arranged onto the rear of the panel 6. One possible configuration is shown in FIG. 1. In the illustrated embodiment, the characters SAFETY are 50 mm high by 30 mm wide. Both the inverter 22 and the charger 30 are 30 mm by 20 mm. The inductor 36 and light dependent resistor 12 occupy approximately 10 mm square. After assembly, all of the electronics can be encapsulated in a polymer resin. The resin surrounds and protects the components as well as securing them to the panel. The resin is supplied as a liquid resin and a hardener or catalyst. The components are liquid until mixed and then set to a watertight flexible seal. A suitable polymer resin sealant can be obtained from Electrolube (RTM) of Wargrave, Berkshire. The front face of the panel may be left exposed or may be encapsulated within the polymer resin if suitably transparent. Sealing of the electronics components in this way makes the electroluminescent device 2 watertight to an IP68 rating which verifies that the device is waterproof against continuous submersion. The electroluminescent panel 6 and stencil 8 could be laminated on the viewing side with the type of thin plastics laminate used to laminate ID cards. A laminate having a weight of 35 g/m² is suitable. The entire device could be sealed together by a lamination process, though care would be necessary not to damage the electronic components by the heat and pressure used in a typical lamination process. For this reason, potting of these components in a resin matrix is preferred.

In an alternative embodiment, the device 2 may be provided with an envelope within which the electroluminescent panel 6 and the electronics components are sealed. The envelope may be made from a flexible polymer material, which is transparent at least in the region covering an exposed part of the electroluminescent panel 6. The envelope provides the device with protection against physical damage.

It will be appreciated that the positioning of the electrical components relative to the electroluminescent panel 6 will vary according to the application of the electroluminescent device 2. It may be possible for the electronics components to be incorporated into the battery.

The complete device 2 can be fixed to high visibility clothing via a polymer pocket or hook and loop fastening.

Electroluminescent devices according to the present invention may be used on life jackets, life rafts, traffic cones, equipment for emergency services, and road signs.

The panels may be fitted to general clothing and fashion items as well as sportswear and decorative elements. With suitable control means 12, the electroluminescent panel can be used as a miss distance indicator in military applications or for war gaming.

Other applications include identity clothing which is required in various industries, such as mining and oil. In such an application, the stencil 8 is shaped to define the necessary pattern of letters.

The electroluminescent device can be fitted to articles such as aviation batons, and to fire extinguishers and blankets that only need to be illuminated under smoke.

There are also applications in safety clothing, such as for children and cycle wear, and backpacks and for sub-aqua activities.

Applications in the advertising industry are also possible.

1. An electroluminescent device having components comprising an electroluminescent panel (6), a rechargeable DC power source (20), charging means for the DC power source, and an inverter (22) connected to the DC power source to power the electroluminescent panel, wherein the components (6, 20, 22) are sealed together and the charging means is adapted to be coupled to an external power supply by means of electrical induction.

2. An electroluminescent device as claimed in claim 1, wherein the components (6, 20, 22) are permanently sealed together.

3. An electroluminescent device as claimed in claim 1, wherein the components (6, 20, 22) are sealed together by means of a polymer matrix.

4. An electroluminescent device as claimed in claim 1, wherein the components (6, 20, 22) are sealed together inside an envelope.

5. An electroluminescent device as claimed in claim 1, wherein the inverter (22) is of the charge pump type.

6. An electroluminescent device as claimed in claim 1, wherein light sensitive means (12) is provided for controlling the power to the panel (6) in response to ambient light levels.

7. An electroluminescent device as claimed in claim 1, wherein smoke sensitive means (12) is provided for controlling power to the panel (6) in response to the presence of smoke.

8. An electroluminescent device as claimed in claim 1, wherein gas sensitive means (12) is provided for controlling power to the panel (6) in response to the presence of gas.

9. An electroluminescent device as claimed in claim 1, wherein water sensitive means (12) is provided for controlling power to the panel (6) in response to the presence of water.

10. An electroluminescent device as claimed in claim 1, wherein electrocardiogram means (12) is provided for controlling power to the panel (6) in response to the presence of a heart beat.

11. An electroluminescent device as claimed in claim 1, wherein an opaque stencil (8) is superimposed in front of the electroluminescent panel (6).

12. An electroluminescent device as claimed in claim 11, wherein the stencil (8) contains a reflective material.

13. An electroluminescent device as claimed in claim 11, wherein the stencil (8) contains a passive luminous material.

14. An electroluminescent device as claimed in claim 1, wherein the electroluminescent panel (6) is shaped to define a desired symbol.

15. An electroluminescent device as claimed in claim 1, wherein phosphorescent material in the electroluminescent panel (6) is shaped to define a desired symbol.

16. Cancelled

17. An electroluminescent device as claimed in 1, wherein the rechargeable DC power source (20) comprises a battery.

18. An electroluminescent device as claimed in claim 17, wherein the DC power source (20) comprises at least one lithium polymer cell.

19. Cancelled

20. Cancelled

21. An electroluminescent device as claimed in claim 1, wherein the DC power source (20) includes a kinetic energy supply.

22. An electroluminescent device as claimed in claim 1, wherein the DC power source (20) includes a water-activated cell.

23. An electroluminescent device as claimed in claim 1, wherein the DC power source (20) includes at least one solar cell.
